(19) United States
(12) Patent Application Publication
(10) Pub. No.: US 2026/0363462 A1
(43) Pub. Date: Nov. 19, 2026

(54) BRACKET FOR MERCHANDISE SECURITY SYSTEM

(71) Applicant: INVUE SECURITY PRODUCTS INC., Charlotte, NC (US)

(72) Inventors: Ashwin Jadhav, Charlotte, NC (US); Nicholas M. Sedon, Weddington, NC (US); Elliott Jernigan, Charlotte, NC (US); Justin A. Richardson, Waxhaw, NC (US)

(21) Appl. No.: 19/103,221

(22) PCT Filed: Aug. 10, 2023
(86) PCT No.: PCT/US2023/029959

§ 371 Date: Feb. 11, 2025

Related U.S. Application Data
(60) Provisional application No. 63/397,592, filed on Aug. 12, 2022.
(60) Provisional application No. 63/398,337, filed on Aug. 16, 2022.

(51) Int. Cl. A47F 7/024; E05B 73/00; F16M 11/04; F16M 11/06; F16M 13/02

(52) U.S. Cl. CPC A47F 7/024; E05B 73/0017; F16M 11/043; F16M 11/06; F16M 13/02; F16M 2200/02

(57) ABSTRACT

A merchandise security system for displaying and protecting a foldable article of merchandise from theft, the foldable article of merchandise configured to move from a first folded position to a second unfolded position, the merchandise security system comprising: a sensor configured to be secured to the foldable article of merchandise and to detect removal of the sensor from the foldable article of merchandise; a bracket plate configured to be attached to the sensor and the foldable article of merchandise such that the bracket plate is positioned between the sensor and the foldable article of merchandise; and at least one mechanical bracket configured to engage the bracket plate and the foldable article of merchandise, wherein the at least one mechanical bracket is configured to engage the foldable article of merchandise to thereby prevent removal of the foldable article of merchandise from the sensor.

### FIELD OF THE INVENTION

This application claims benefit of priority to U.S. Provisional Application No. 63/397,592, filed on Aug. 12, 2022, and U.S. Provisional Application No. 63/398,337, filed on Aug. 16, 2022, the entire disclosures of which are incorporated herein by reference.

### BACKGROUND OF THE INVENTION

Retailers routinely display articles of merchandise, such as telephones, portable computers (e.g., notebooks, laptops, tablets, etc.), e-readers, media players, and the like for customers to evaluate before making a purchase. Such merchandise is vulnerable and susceptible to theft. Accordingly, these articles of merchandise need to be secured from theft.

### BRIEF SUMMARY

Embodiments of the present invention are directed towards merchandise security systems for displaying and protecting foldable articles of merchandise from theft. The foldable article of merchandise may be configured to move from a first folded position to a second unfolded position, the merchandise security system comprising. In one embodiment, a merchandise security system includes a sensor configured to be secured to the foldable article of merchandise and to detect removal of the sensor from the foldable article of merchandise and a bracket plate configured to be attached to the sensor and the foldable article of merchandise such that the bracket plate is positioned between the sensor and the foldable article of merchandise. The merchandise security system further includes at least one mechanical bracket configured to engage the bracket plate and the foldable article of merchandise, wherein the at least one mechanical bracket is configured to engage the foldable article of merchandise to thereby prevent removal of the foldable article of merchandise from the sensor.

In another embodiment, a merchandise security system includes a sensor configured to be secured to the foldable article of merchandise and to detect removal of the sensor from the foldable article of merchandise and a bracket plate configured to be attached to the sensor and the foldable article of merchandise such that the bracket plate is positioned between the sensor and the foldable article of merchandise. The merchandise security system further includes at least one mechanical bracket configured to engage the bracket plate and the foldable article of merchandise, wherein the at least one mechanical bracket is configured to engage the foldable article of merchandise to thereby prevent removal of the foldable article of merchandise from the sensor and to automatically return the article of merchandise to a predetermined display position.

In another embodiment, a method for displaying and protecting a foldable article of merchandise from theft is provided. The method includes securing a sensor to the foldable article of merchandise for detecting removal of the sensor from the foldable article of merchandise and attaching a bracket plate to the sensor and the foldable article of merchandise such that the bracket plate is positioned between the sensor and the foldable article of merchandise. The method further includes engaging at least one mechanical bracket with the bracket plate and the foldable article of merchandise to thereby prevent removal of the foldable article of merchandise from the sensor.

### BRIEF DESCRIPTION OF THE DRAWINGS

FIG. 1 is an exploded view of a security device according to one embodiment of the present invention.

FIG. 2 is a perspective view of a base of a security device according to one embodiment.

FIG. 3 is a rear view of the base shown in FIG. 2.

FIG. 4 is a perspective view of a sensor of a security device according to one embodiment.

FIG. 5 is a bottom view of the sensor shown in FIG. 4.

FIG. 6 is a partial view of the sensor shown in FIG. 4.

FIG. 7 is a partial view of the sensor shown in FIG. 4.

FIG. 8 is a perspective view of a connector at the end of the cable according to one embodiment.

FIG. 9 is a cross-sectional view of a sensor according to one embodiment of the present invention.

FIG. 10 is a perspective view of a connector in engagement with a movable member according to one embodiment.

FIG. 11 is a perspective view of a key according to one embodiment.

FIG. 12 is a perspective view of a merchandise security system for displaying and protecting a foldable article of merchandise from theft according to one embodiment.

FIG. 13 is a side view of the merchandise security system of FIG. 12.

FIG. 14 is a rear perspective view of the merchandise security system of FIG. 12.

FIG. 15 is a perspective view of a mechanical bracket according to one embodiment.

FIG. 16 is a side view of the mechanical bracket shown in FIG. 15.

FIG. 17 is a side view of a mechanical bracket in a display position according to another embodiment.

FIG. 18 is another side view of the mechanical bracket shown in FIG. 17 in an extended position.

FIG. 19 is a perspective view of the mechanical bracket shown in FIG. 17.

FIG. 20 is a rear perspective view of the mechanical bracket shown in FIG. 17.

FIG. 21 is a side view of a merchandise security system for displaying and protecting a foldable article of merchandise from theft according to one embodiment.

FIG. 22 is a perspective view of a merchandise security system for displaying and protecting a foldable article of merchandise from theft according to one embodiment.

### DETAILED DESCRIPTION OF EMBODIMENTS OF THE INVENTION

One or more embodiments of a merchandise security system for displaying an article of merchandise are shown in the accompanying drawing figures and described below. The article of merchandise is typically a display model or an operational sample of electronic merchandise, such as portable telephones, smart phones, computers (e.g. notebooks, laptops, tablets, etc.), e-readers, media players, and the like, for a customer to examine before making a decision whether to purchase the article. The article of merchandise is typically displayed in a manner that permits a prospective purchaser to evaluate the operation and features of the merchandise, while protecting the merchandise from theft. In one embodiment, a sensor may be attached to the article of merchandise for detecting various alarming conditions, such as the article being removed from the sensor. A cable may be operably engaged with the sensor at one end, while the opposite end may be secured to a recoiler. As explained in further detail below, the sensor may also be configured to detect an alarming condition of the cable, such as a cutting, severing, removing, or detaching of the cable.

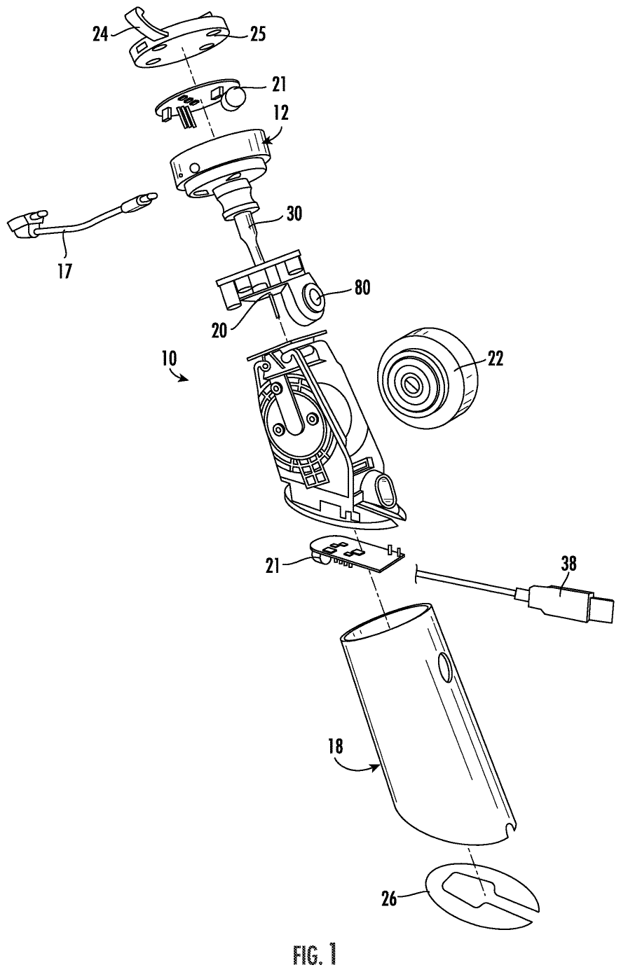

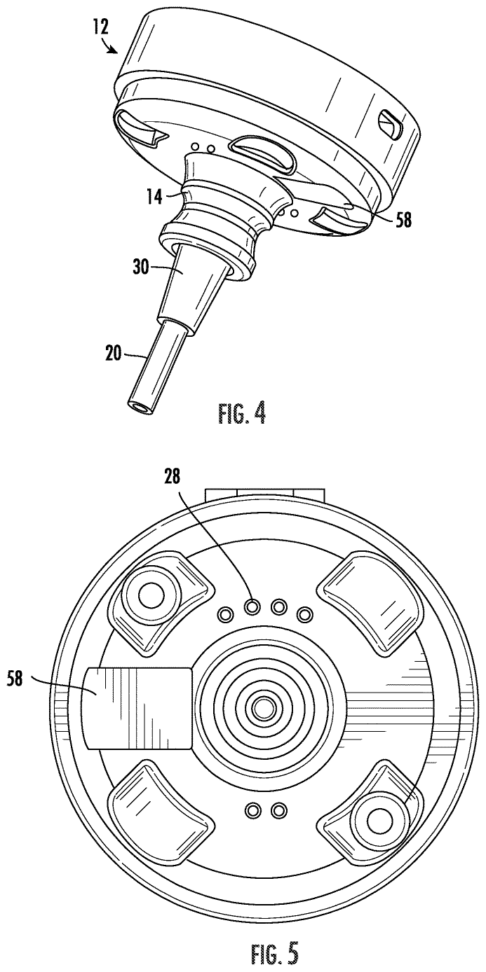

According to one embodiment shown in FIG. 1, the security system 10 generally comprises a sensor 12 configured to be secured to an item of merchandise. The sensor 12 may be electrically connected to a connector 17 that is configured to electrically connect to an input jack of the item of merchandise. The security system 10 may also include a base 18 that is configured to removably support the sensor 12 and the item of merchandise thereon. In some embodiments, the base 18 and the sensor 12 include one or more contacts 28, 40 for facilitating contact charging when the sensor is supported on the base (see, e.g., FIGS. 2 and 5). In one embodiment, the security system 10 also includes a cable 20 that is coupled to the sensor 12 at one end and operably engaged with a recoiler 22 at an opposite end. As explained in further detail below, in some embodiments, a sense circuit or loop may be defined through the cable 20 and the sensor 12, and the sense loop may be used to detect various security events associated with the cable 20, such as the cable being cut, shorted, and/or disconnected. The security system 10 may also include a charging circuit for charging of the item of merchandise and/or a power source carried by the sensor 12 and/or the base 18. The sensor 12 may also be used to detect security events associated with the sensor and/or the item of merchandise, such as the item of merchandise being removed from the sensor.

The sensor 12 may be secured to the item of merchandise using any desired technique, such as an adhesive and/or mechanical brackets 24. For instance, FIG. 1 shows mechanical brackets 24 that may be attached to the sensor 12 with a bracket plate 25 using fasteners. The mechanical brackets 24 may be adjustable relative to the sensor 12 for accommodating different sized articles of merchandise. The sensor 12 may have a variety of shapes and sizes for being secured to the item of merchandise. In one embodiment shown in the cross-sectional view of FIG. 9, the sensor 12 may include a sensing device 15, such as a pressure or plunger switch, for detecting removal of the item of merchandise. In addition, the connector 17 may be configured to be removably inserted into the input jack of the item of merchandise. Thus, the sensor 12 and the item of merchandise may be electrically connected via the connector 17. The sensor 12 may include a printed circuit board (PCB) 21, circuitry, or the like. For example, the sensor 12 may include charging circuitry for facilitating power transfer between the base 18 and the item of merchandise. The connector 17 may be electrically connected to the PCB 21. In the illustrated embodiment, the connector 17 is mounted to and extends from the sensor 12 but could be positioned at other locations depending on the location of the input port of the item of merchandise.

As noted above, the sensor 12 may include one or more electrical contacts 28. In some embodiments, the sensor 12 includes a plurality of electrical contacts 28. The electrical contacts 28 may be in electrical communication with the PCB 21 in the sensor 12 and the connector 17. Alternatively, the electrical contacts 28 may be electrically connected to only the connector 17. In some embodiments, the sensor 12 may not supply power to the item of merchandise when the item is lifted from the base 18. Rather, the item of merchandise may operate using its own power source when lifted from the base 18.

The base 18 may be configured to be supported by a fixed support or display surface, such as a counter, shelf, fixture, or the like. The base 18 may be secured to the support surface using any desired technique such as an adhesive 26, brackets, and/or fasteners. The base 18 may include one or more magnets 34 or magnetic material, and the sensor 12 may include one or more magnets 36 or magnetic material for releasably holding the sensor on the base. The magnets 34, 36 may aid in aligning the item of merchandise in a desired display orientation.

The security system 10 may include a recoiler 22 and a cable 20 as discussed above. The base 18 may include an opening for receiving the cable 20. As such, the cable 20 may be extended through the opening when the sensor 12 and the item of merchandise are lifted from the base, and the cable may be retracted through the opening when the sensor and the item of merchandise are returned to the base. The recoiler 22 may be spring biased in some embodiments such that the cable 20 is automatically retracted within the recoiler. The recoiler 22 may be housed within the base 18 and mounted on top of a support surface (see, e.g., FIG. 1), although in other embodiments, the recoiler may be mounted to an underside of the support surface. Furthermore, the recoiler 22 may be in electrical communication with the cable 20. In this regard, the cable 20 may include one or more electrical conductors 23 extending along the length of the cable. In some cases, the cable 20 may include a pair of conductors 23 for defining a sense loop or circuit and conducting an electrical signal. In other cases, the cable 20 may include a single conductor 23, such as an optical conductor for conducting an optical signal (e.g., a fiber optic cable). Moreover, in other embodiments, a recoiler 22 may be omitted, such as in the case where an elastic or helical cable 20 is utilized.

Should the sense loop be interrupted, the base 18 or other alarm unit may detect the interruption and generate an alarm signal. For example, the base 18 or other alarm unit may be configured to generate an audible and/or a visible alarm. The sensor 12 may likewise or alternatively include an alarm 45 for generating an audible and/or a visible alarm. The sensor 12 and/or the base 18 may be configured to be armed and/or disarmed via a key, such as a wireless key having a code that must match a code stored by the sensor and/or the base. For instance, FIG. 4 shows that the sensor 12 may include a port 45 for facilitating communication with a key.

As discussed above, the base 18 may include one or more electrical contacts 40. The contacts 28, 40 of the base 18 and the sensor 12 are configured to align with one another and contact one another when the sensor is supported on the base. Thus, the base 18 and the sensor 12 are in electrical communication with one another when the sensor is supported on the base. The base 18 may be electrically connected to a power source with a connector 38 that is configured to provide power to the base and/or the one or more electrical contacts 40 in the base. The base 18 may include one or more printed circuit boards (PCB) 21, circuitry, or the like for facilitating power transfer. The base 18 may also include charging circuitry that is configured to facilitate power transfer from the external power source 38 and the electrical contacts 40. Thus, when the sensor 12 is supported on the base 18, power is able to be transferred between the contacts 28, 40 and to the sensor 12. The connector 17 is electrically connected to the sensor contacts 28 as power is delivered such that power is provided to the item of merchandise. Therefore, the item of merchandise may be powered by power transferred thereto and may be used to charge a battery associated with the item of merchandise. In some embodiments, any voltage adaption occurs prior to being delivered to the sensor 12. Voltage adaption may be needed in order to accommodate different items of merchandise that require different operating voltages. Any voltage adaption may occur prior to power being provided to the contacts 28 on the sensor 12. Thus, the sensor 12 and adapter cable 16 do not provide any voltage adaption. However, in other embodiments, the sensor 12 may include a resistor or other identifier that detects the voltage requirements of the item of merchandise which provides a signal to the sensor or the base 18 for adjusting the voltage as necessary before providing power to the article. Although the aforementioned embodiments describe that power may be transferred via contact charging, it is understood that other techniques could be used to transfer power to sensor 12 and the item of merchandise. For example, inductive charging functionality could be employed for transferring power. Moreover, in some cases, the cable 20 may include one or more conductors 23 for transferring power to the sensor 12 and/or the item of merchandise.

In some cases, the base 18 and the sensor 12 may include an electrical contact 28, 40 that detects that the sensor is lifted off of the base. For example, the sensor 12 and base 18 may each include a contact 28, 40 that is configured to engage one another when the sensor is supported on the base. These contacts 28, 40 may not transfer power. However, the contact on the base 18 may communicate with the PCB to indicate when the sensor 12 has been lifted off of the base and to cease transferring power to the electrical contacts 28, 40. This arrangement of contacts 28, 40 may reduce arcing and power surges when the sensor 12 is placed back on the base 18 since power will no longer be transferred to the contacts on the base after the sensor is lifted. Moreover, the base 18 and the sensor 12 may include an electrical contact 28, 40 that facilitates power transfer as discussed above, as well as for utilizing the USB Power Delivery (PD) specification for providing power to the item of merchandise. Thus, in some embodiments, the sensor 12 and base 18 may each have four electrical contacts (e.g., power, ground, PD, and lift detection). Additional contacts 28, 40 may be provided for redundancy to allow for rotation of the sensor 12 on the base 18 while maintaining electrical communication. For example, FIG. 2 shows that the base 18 may include four sets of four contacts to allow for electrical communication to be maintained as the sensor 12 is seated on the base at different orientations.

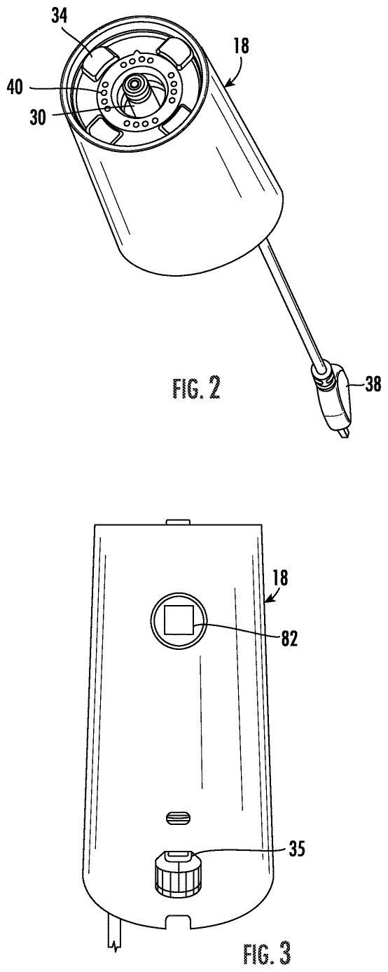

Furthermore, the base 18, 18′ may include one or more auxiliary ports 35 for connecting to corresponding auxiliary devices for the item of merchandise (see, e.g., FIG. 3). Thus, in addition to securing an item of merchandise and electrically connecting to a power cord 38 and associated input power source, the base 18 may be configured to electrically connect to an auxiliary device, such as, for example, an auxiliary device for the item of merchandise on display (e.g., a stylus, speaker, keyboard, Bluetooth device, etc.). The auxiliary port 35 may be an input port (e.g., a micro-USB port) that is configured to receive a corresponding input connector that is electrically connected to the auxiliary device. When the input connector is connected to the auxiliary port 35, the auxiliary port may be configured to receive power, if necessary, and/or define a sense loop that may be used to detect various security events associated with the auxiliary device, such as the input connector being removed from the base 18 in an unauthorized manner. The auxiliary port 35 may be part of the same sense loop defined with the sensor 12 and the cable 20, or may define a separate sense loop. In the instance where the auxiliary port 35 is configured to provide power, the charging circuit may be configured to determine the power requirements of the auxiliary device and provide the necessary power level to effectuate charging. In some cases, the charging circuit may be configured to reduce the amount of power being provided to the sensor 12 and/or the item of merchandise so that power may be provided to the auxiliary device while still facilitating charging of the sensor and/or the item of merchandise. Therefore, the auxiliary port 35 allows an auxiliary device to be displayed and used by a prospective consumer in connection with an item of merchandise, while the retailer is able to also power and protect both the item of merchandise and the auxiliary device from theft with a single security device rather than requiring two separate security devices.

It is understood that the cable 20 may be any suitable cord, tether, or the like. In addition, the cable 20 may include one or more electrical conductors 23 for transmitting electrical, security, and/or communication signals. In addition, the cable 20 may be a single strand, multi-strand, or braided. The cable 20 may be flexible to facilitate extension and retraction relative to the recoiler 22, and in some embodiments, may be formed of a cut-resistant material. Furthermore, the cable 20 may have various cross sections, such as round or flat. In the case where power is facilitated through electrical contacts 28, 40, the cable 20 may have a pair of conductors 23 for defining the sense loop and/or for transferring data.

In one embodiment, an end of cable 20 may be electrically connected to the sensor 12. In one embodiment, the sensor 12 may be configured to releasably engage an end of the cable 20. The end of the cable 20 may include a releasable connector 30 that is configured to be received by a receptacle 32 on the sensor 12. The sensor 12 may include a cylindrical portion 14 that extends axially from a rear surface of the sensor. This cylindrical portion 14 may be configured to receive at least a portion of the connector 30. In some embodiments, the connector 30 includes one or more electrical contacts for electrically connecting to one or more electrical contacts on the sensor 12. For example, the connector 30 may include a plurality of contacts, e.g., one contact 42 at the end of the connector (e.g., a spring-biased pogo pin) and another contact 44 that surrounds the contact 42 (e.g., a hemispherical, rounded, or frustroconical shaped contact). The connector 30 may be assembled such that the contacts 42 and 44 are electrically insulated from one another. The sensor 12 may also include a plurality of contacts 48, 49, wherein the receptacle 32 includes at least one contact 48, and another contact 49 is electrically connected to the PCB 21. In some cases, a pair of radially opposed contacts 48 may be provided in the receptacle 32, which may ensure electrical communication with the connector 30. The contact 42 is configured to mate with and engage the contact 49, while contact 44 is configured to mate with and engage contact(s) 48.

Furthermore, the end of the cable 20 may be coupled to the sensor 12 using a variety of techniques and may be configured to rotate or swivel in some embodiments. In one example, the electrical contacts 42, 44 of the connector 30 may be configured to rotate or swivel relative to the contacts 48, 49 on the sensor 12 while maintaining a mechanical and an electrical connection. As discussed above, the cable 20 may include a plurality of conductors 23 and these conductors may define a sense loop. One conductor 23 may be connected to contact 42, while another conductor 23 may be connected to contact 44. Thus, when the connector 30 is engaged with sensor 12, the electrical connection therebetween forms a detectable sense loop formed with the conductors 23 in the cable and the electrical contacts 42, 44, 48, 49 between the connector and the sensor. Typically the connector 30 and sensor 12 would maintain electrical contact when the sensor is lifted off of the base, although it is contemplated that in alternative embodiments that the connector and sensor may electrically disconnect when the sensor is lifted off of the base, such as due to tension being applied to the cable 20. This latter embodiment may reduce wear on the electrical contacts and friction for swiveling between the connector 30 and the sensor 12.

In one embodiment, a lock mechanism 50 may be provided for locking the end of the cable 20 to the sensor 12. For example, the lock mechanism 50 may include a movable member 52 that is configured to releasably engage the connector 30. The connector 30 may include a slot 54 (e.g., a circumferentially extending slot) or like engagement member that is configured to be engaged by the movable member 52. In one example where the slot 54 extends about the entire circumference of the connector 30, the movable member 52 may be configured to engage at least half of the circumference of the slot 54. In some instances, the movable member 52 is configured to move laterally within the sensor 12 (i.e., not axially) between locked and unlocked positions. The connector 30 may be configured to engage the sensor 12 in an axial direction perpendicular to the movement of the movable member 52. The movable member 52 may be biased towards a locked position, e.g., with a spring 56. The end of the connector 30 is shaped (e.g., curved) such that inserting the connector into sensor 12 urges the movable member 52 to overcome the spring 56 bias and move towards an unlocked position until the connector is received within the receptacle 32. Once the connector 30 is received within the receptacle 32 of the sensor 12, the spring 56 is then able to bias the movable member 52 back towards the locked position such that the movable member engages the slot 54. Thus, in some cases, the lock mechanism 50 may be configured to automatically lock the connector 30 to the sensor 12 in response to engagement of the connector with the sensor.

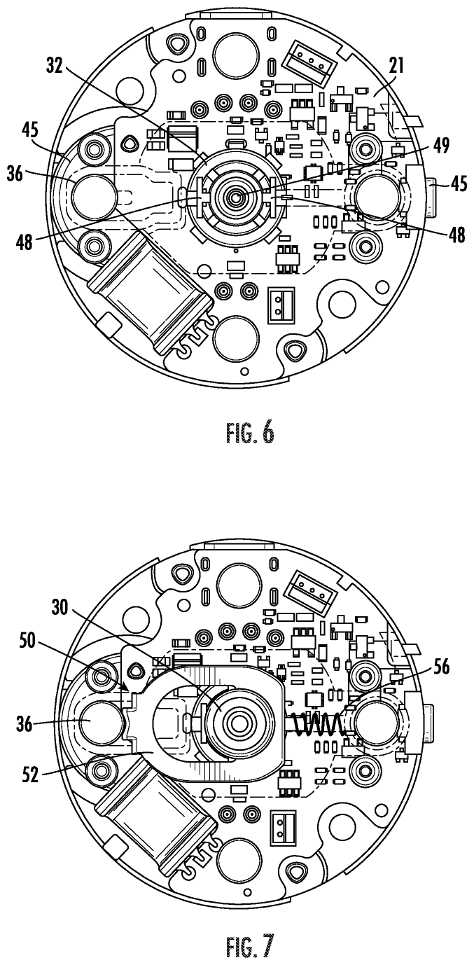

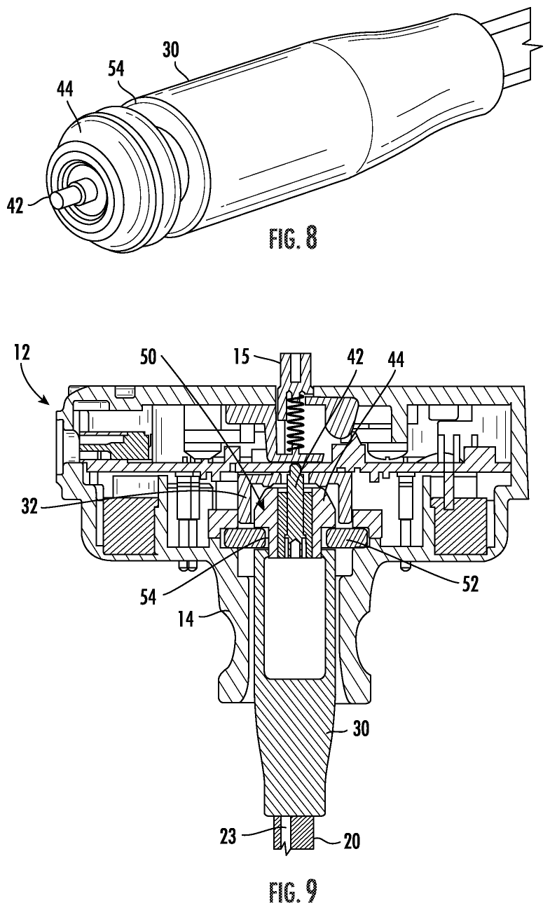

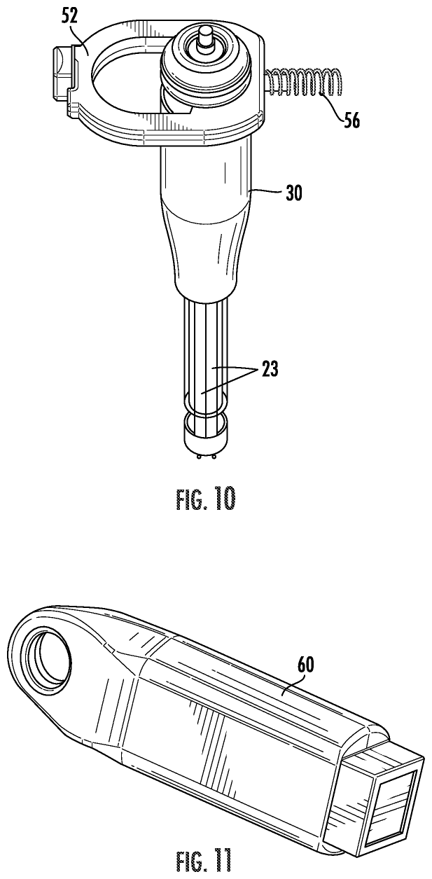

To unlock the lock mechanism 50 to allow removal of the connector 30 from the sensor 12, a key 60 may be necessary. In some embodiments, the key 60 is a magnetic key that is configured to attract to one of the magnets 36 on the sensor 12 adjacent to the movable member 52 (see, e.g., FIG. 7). While the magnetic key 60 is magnetically engaged with this magnet 36, a user may then move the magnet and movable member 52 towards the unlocked position and to overcome the bias of the spring 56. In this way, the user is then able to remove the connector 30 from the sensor 12 due to disengagement of the movable member 52 from the connector using the magnetic key 60. The sensor 12 may define a recess 58 or other locating feature that allows the user to locate the magnetic key 60 in the desired location for unlocking the lock mechanism 50. In addition, in some embodiments, the lock mechanism 50 is needed to ensure that an electrical connection between the connector 30 and the sensor 12 is maintained. For instance, without utilization of the lock mechanism 50, the connector 30 cannot remain engaged with the receptacle 32 of the sensor 12. Thus, the combination of electrical contacts 42, 44, 48, 49 of the connector 30 and sensor 12 and engagement of the lock mechanism 50 ensures an electrical connection therebetween.

In another embodiment, a locking feature may be provided for locking the sensor 12 to the base 18. In this regard and with reference to FIG. 1, a lock mechanism 80 may be configured to lock the sensor 12 to the base 18 when the sensor is seated on the base 18 to thereby prevent the cable 20 from being retracted relative to the base. Such a lock mechanism 80 may be useful for retailers who wish to secure the sensor 12 and item of merchandise to the base 18, such as after hours, since the cable 20 will be inaccessible due to the inability to lift the sensor from the base. In the illustrated embodiment, the lock mechanism 80 includes a locking member 82 that is configured to rotate between locked and unlocked positions. In this instance, the locking member 82 may be a proprietary key, which could be the same key 60 that is used to actuate the lock mechanism 50.

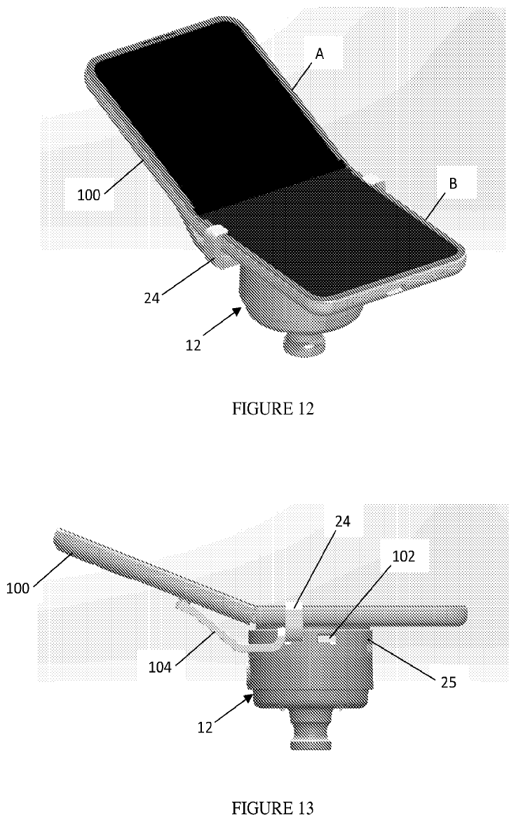

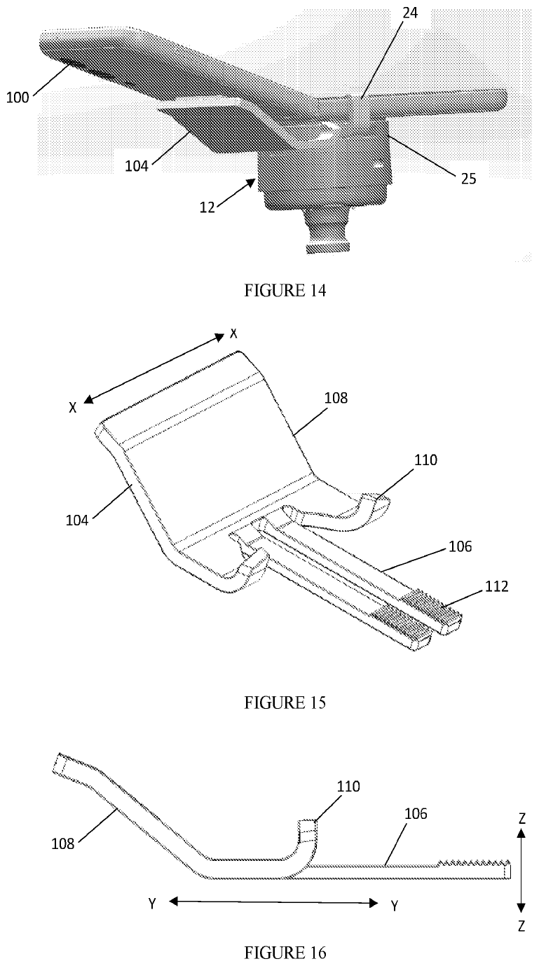

In other embodiments, FIGS. 12-14 illustrate a sensor 12 and a bracket plate 25 for accommodating one or mechanical brackets 24 for securing an article of merchandise 100. In this embodiment, the article of merchandise 100 may be a flip or foldable article of merchandise, such as a flip cellular phone. As shown, the mechanical brackets 24 may take different forms in order to prevent removal of the article of merchandise 100 from the sensor 12. The mechanical brackets 24 may be a metal or other non-flexible material. The plate 25 may define one or more slots 102 for receiving the mechanical brackets 24, which may allow for flexibility in the type and placement of the brackets relative to the article of merchandise 100. When the plate 25 is secured to the sensor 12 (e.g., via one or more fasteners), the mechanical brackets 24 are secured in position relative to the article of merchandise 100. The mechanical brackets 24 may include serrated surfaces 112 to aid in securing the brackets relative to the sensor 12 when secured together. In one example, a pair of mechanical brackets 24 may be configured to extend from the sensor 12 and engage lateral sides of the article of merchandise 100. The ends of the mechanical brackets 24 may be C-shaped in some cases to facilitate placement of the brackets around the edges of the article of merchandise 100.

A flip or foldable article of merchandise 100 may present challenges with mechanical brackets in securing the article of merchandise from theft while also allowing a degree of freedom for customer interaction. In the illustrated embodiment, the article of merchandise 100 is configured to move between a first, open position to a second closed position (e.g., between 0 and 180 degrees between the open and closed positions). Conventional brackets for rectangularly shaped articles of merchandise that are secured to all four sides of the article would not allow for this level of interaction. In order to secure a flip or foldable article of merchandise 100, an additional mechanical bracket 104 is provided in one embodiment. As shown in FIGS. 12 4, the mechanical bracket 104 is configured to engage one or more slots 102 of the plate 25 and extend under a rear surface of the article of merchandise 100. As shown, the article of merchandise 100 may have a first part A that is configured to fold or pivot relative to a second part B. The mechanical bracket 104 may be configured to extend under at least a portion of both the first and second parts. In this way, the article of merchandise 100 is unable to be removed from the sensor 12 without damaging the article of merchandise, as attempting to slide or pry the article from the sensor will likely result in damage to the article. In some implementations, the article of merchandise 100 may be secured by the mechanical bracket 104 such that the first and second parts do not extend parallel to one another in its display position (see, e.g., FIG. 13).

FIGS. 15-16 show an embodiment of the mechanical bracket 104 where the bracket includes a first portion 106 configured to be received by the plate 25 and a second portion 108 configured to engage the article of merchandise 100. The first portion 106 may be configured to be received by one or more slots 102 of the plate 25. In one example, the first portion 106 may extend generally linearly, while the second portion 108 may extend at an obtuse angle relative to the first portion (see, e.g., FIG. 16). The angle of the second portion 108 may prevent sliding of the article of merchandise 100 in a first Y-direction in an attempt to remove the article from the brackets, and mechanical bracket 24 may prevent sliding of the article in an opposite Y-direction and lifting of the article in a Z-direction relative to the sensor 12. Mechanical brackets 24 may further prevent movement of the article of merchandise in an X-direction. In addition, the second portion 108 prevents the first and second parts of the article of merchandise 100 from being extended parallel to one another in the unfolded position. In combination, the mechanical brackets 24, 104 provide a more secure attachment between the sensor 12 and the article of merchandise 100. As shown in FIG. 16, the second portion 108 may be generally J-or hook-shaped in one example. Moreover, in some cases, the second portion 108 may be wider than the first portion 106 so as to span substantially the width of the article of merchandise 100 (or be about the same width as the article) but not extend over the side edges of the article. Thus, in some cases, the second portion 108 may remain hidden from view, e.g., when viewing the top surface of the article 100. In some instances, the second portion 108 may include one or more projections 110 configured to extend upwardly relative to the first portion 106. The projections 110 may be configured to be positioned in contact or close contact to a rear surface of the article of merchandise 100 to prevent prying of the article without damage thereto. In the illustrated embodiment, the projections 110 are configured to extend under a first part of the article of merchandise 100, while the remaining second portion 108 may extend under a second part of the article.

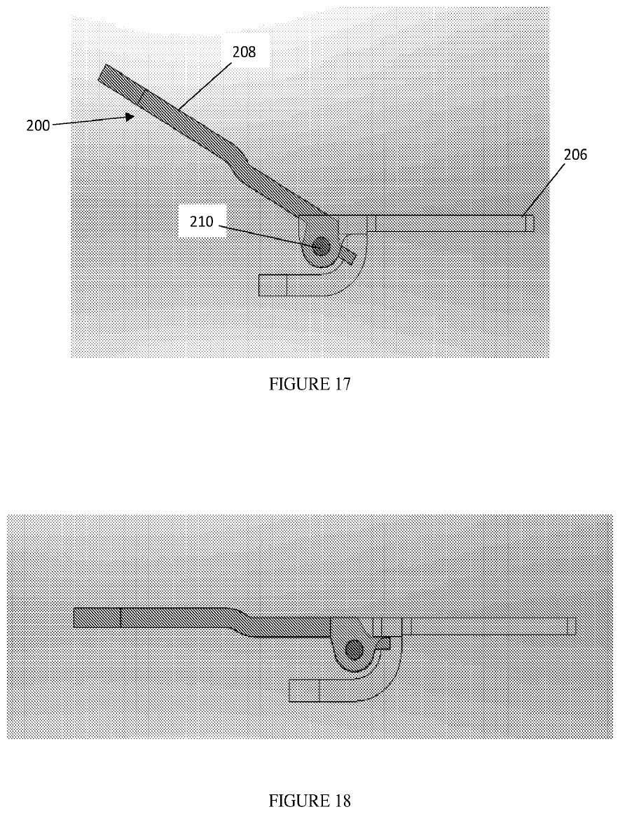

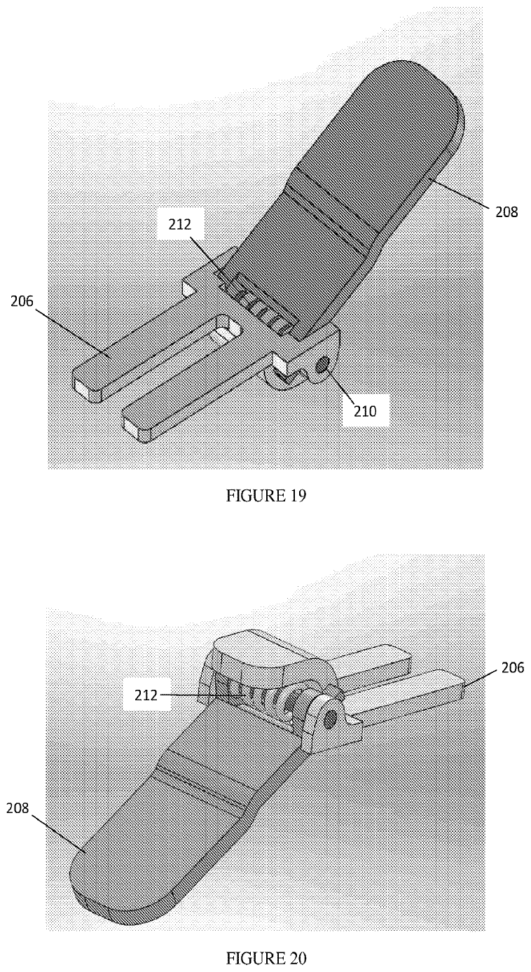

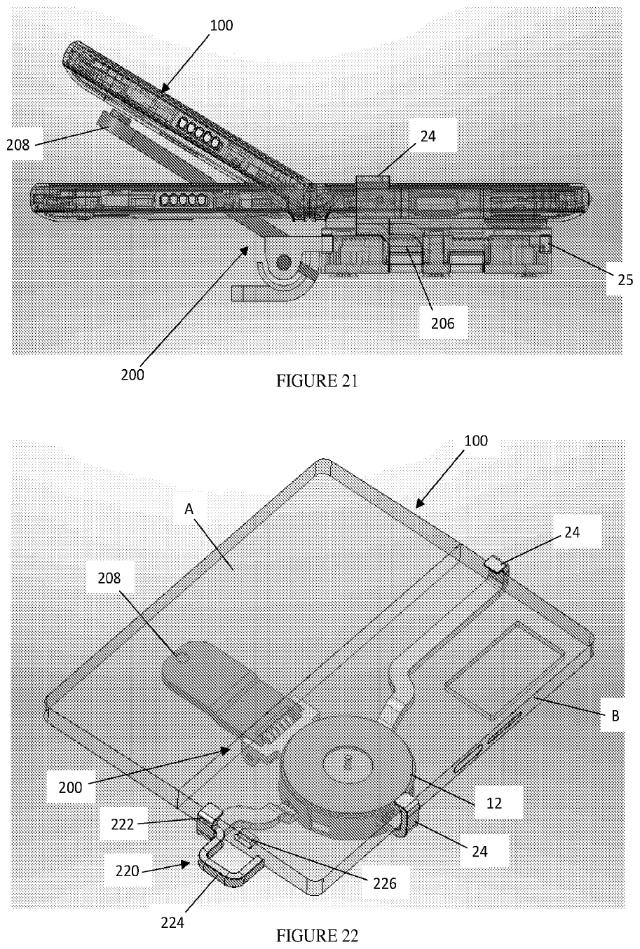

FIGS. 17-19 illustrate another embodiment of a mechanical bracket 200. Similar to the embodiments described above, the mechanical bracket 200 may include a first portion 206 configured to be received by the plate 25 and a second portion 208 configured to engage a rear surface of the article of merchandise 100 (see, e.g., FIG. 21). In this particular example, the second portion 208 is configured to pivot or otherwise move relative to the first portion 206 via a hinge 210. In some cases, the second portion 208 may be configured to pivot between a plurality of positions (e.g. between 0 and 180 degrees), where a first position is an extended, unfolded position (see, e.g., FIG. 18), a second position is a partially folded, display position (see, e.g., FIG. 17), and a third position is a folded position. The mechanical bracket 200 may include a biasing member 212 (e.g., a torsion spring) configured to bias the second portion 208 to a predetermined position, such as the display position. The predetermined display position (e.g., FIG. 17) may be a predetermined angle relative to the extended, unfolded position (e.g., 20-40 degrees or about 30 degrees). Thus, the mechanical bracket 200 may be configured to hold the first part A and the second part B of the article 100 in a predetermined display position. In this way, the article 100 is configured to be automatically returned to a desired display position after manipulation by a consumer.

As shown in the example in FIG. 22, a mechanical bracket 220 is provided that is also configured to engage the plate 25. In this example, the mechanical bracket 220 includes a first portion 222 configured to engage a lateral edge of the article of merchandise 100 and a second portion 224 configured to extend around or surround an input jack 226 of the article along the lateral edge. The second portion 224 may be U-shaped in some cases and be configured to allow a connector 17 to engage the input jack 226 disposed on the lateral edge of the article 100. The sensor 12 may be configured to detect removal of the connector 17 from the input jack 226. Thus, any unauthorized attempt to slide or otherwise remove the bracket 220 from the article of merchandise 100 will result in removal of the connector 17. In some cases, the first 222 and second 224 portions may be integrally formed from a metal or other rigid material. In the illustrated example, three brackets 24, 24, 220 are configured to engage respective lateral edges of the article 100 on a first part of the article, while the mechanical bracket 200 is configured to engage the second part of the article.

The foregoing has described one or more embodiments of recoilers, merchandise security systems, and methods for displaying and protecting an article of merchandise from theft. Those of ordinary skill in the art will understand and appreciate that numerous variations and modifications of the invention may be made without departing from the spirit and broad scope of the invention. Accordingly, all such variations and modifications are intended to be encompassed by the appended claims.

1. A merchandise security system for displaying and protecting a foldable article of merchandise from theft, the foldable article of merchandise configured to move from a first folded position to a second unfolded position, the merchandise security system comprising:
a sensor configured to be secured to the foldable article of merchandise and to detect removal of the sensor from the foldable article of merchandise;
a bracket plate configured to be attached to the sensor and the foldable article of merchandise such that the bracket plate is positioned between the sensor and the foldable article of merchandise; and
at least one mechanical bracket configured to engage the bracket plate and the foldable article of merchandise,
wherein the at least one mechanical bracket is configured to engage the foldable article of merchandise to thereby prevent removal of the foldable article of merchandise from the sensor.

2. The merchandise security system of claim 1, further comprising a plurality of mechanical brackets, wherein at least one of the mechanical brackets is configured to engage lateral edges of the foldable article of merchandise and at least one other of the mechanical brackets is configured to only engage a rear surface of the foldable article of merchandise.

3. The merchandise security system of claim 1, further comprising a cable configured to be connected to the sensor to establish electrical communication therebetween.

4. The merchandise security system of claim 3, further comprising a base for removably supporting the sensor and the article of merchandise thereon, wherein the cable is configured to be extended relative to the base in response to the sensor being lifted off of the base, and wherein the cable is configured to retract relative to the base in response to the sensor being moved to a seated position on the base.

5. The merchandise security system of claim 1, wherein the at least one mechanical bracket is configured to automatically return the article of merchandise to a predetermined display position.

6. The merchandise security system of claim 5, wherein the predetermined display position is a position between the first folded position and the second unfolded position.

7. The merchandise security system of claim 1, wherein the at least one mechanical bracket comprises a first portion configured to pivot relative to a second portion.

8. The merchandise security system of claim 7, wherein the first portion is biased relative to the second portion.

9. The merchandise security system of claim 1, further comprising a second mechanical bracket comprising a first portion configured to engage a lateral edge of the article of merchandise.

10. The merchandise security system of claim 9, wherein the second mechanical bracket comprises a second portion configured to extend around an input jack of the article of merchandise.

11. The merchandise security system of claim 1, wherein the at least one mechanical bracket is configured to removably engage the bracket plate.

12. The merchandise security system of claim 1, wherein the at least one mechanical bracket is configured to be removed from bracket plate while the bracket plate remains attached to the foldable article of merchandise and the sensor.

13. The merchandise security system of claim 1, wherein the at least one mechanical bracket comprises a first portion and a second portion, and wherein the at least one mechanical bracket is configured to engage a rear surface of each of the first portion and the second portion.

14. (canceled)

15. A merchandise security system for displaying and protecting a foldable article of merchandise from theft, the foldable article of merchandise configured to move from a first folded position to a second unfolded position, the merchandise security system comprising:
a sensor configured to be secured to the foldable article of merchandise and to detect removal of the sensor from the foldable article of merchandise;
a bracket plate configured to be attached to the sensor and the foldable article of merchandise such that the bracket plate is positioned between the sensor and the foldable article of merchandise; and
at least one mechanical bracket configured to engage the bracket plate and the foldable article of merchandise,
wherein the at least one mechanical bracket is configured to engage the foldable article of merchandise to thereby prevent removal of the foldable article of merchandise from the sensor and to automatically return the article of merchandise to a predetermined display position.

16. The merchandise security system of claim 15, further comprising a plurality of mechanical brackets, wherein at least one of the mechanical brackets is configured to engage lateral edges of the foldable article of merchandise and at least one other of the mechanical brackets is configured to only engage a rear surface of the foldable article of merchandise.

17. The merchandise security system of claim 15, wherein the at least one mechanical bracket comprises a first portion configured to pivot relative to a second portion.

18. The merchandise security system of claim 17, wherein the first portion is biased relative to the second portion.

19. The merchandise security system of claim 15, wherein the predetermined display position is a position between the first folded position and the second unfolded position.

20. The merchandise security system of claim 15, further comprising a second mechanical bracket comprising a first portion configured to engage a lateral edge of the article of merchandise.

21. The merchandise security system of claim 20, wherein the second mechanical bracket comprises a second portion configured to extend around an input jack of the article of merchandise.

22. (canceled)

23. A method for displaying and protecting a foldable article of merchandise from theft, the foldable article of merchandise configured to move from a first folded position to a second unfolded position, the method comprising:
securing a sensor to the foldable article of merchandise for detecting removal of the sensor from the foldable article of merchandise;
attaching a bracket plate to the sensor and the foldable article of merchandise such that the bracket plate is positioned between the sensor and the foldable article of merchandise; and
engaging at least one mechanical bracket with the bracket plate and the foldable article of merchandise to thereby prevent removal of the foldable article of merchandise from the sensor.

24. (canceled)
